(19) United States
(12) Patent Application Publication
(10) Pub. No.: US 2021/0287565 A1
(43) Pub. Date: Sep. 16, 2021

(54) GAME MONITORING AND PLAY DECISION-MAKING RECOMMENDATION SYSTEM

(71) Applicant: EdjAnalytics, LLC, Louisville, KY (US)

(72) Inventors: Sean O'Leary, Louisville, KY (US); Frank Frigo, Louisville, KY (US); Chuck Bower, Bloomington, IN (US)

(21) Appl. No.: 16/986,124

(22) Filed: Aug. 5, 2020

Related U.S. Application Data
(60) Provisional application No. 62/990,094, filed on Mar. 16, 2020.

(51) Int. Cl. G09B 19/00; A63B 69/00

(52) U.S. Cl. CPC G09B 19/0038; A63B 69/002

(57) ABSTRACT

A monitoring and play making recommendation system for the sport of football that uses a combination of historical and real-time data for proving a coaching recommendation. In one example, the coaching recommendation is based on a fourth-down play and includes a recommendation to attempt a field goal, punt, or attempt a fourth down conversion. Each recommendation is associated with a team's ultimate game winning probability. Data relied upon by the system can be changed based on predetermined profile data for various on-field teams or by changing individual team attributes based on the absence or presence of individual players. Recommendations are provided as visualizations and relayed to a user interface. The system may also work on a media platform for modifying live video feeds and presenting certain game winning opportunity graphics to home viewers.

### CROSS-REFERENCE TO RELATED APPLICATION

This U.S. patent application claims priority to and the benefit of U.S. provisional patent application No. 62/990,094, filed Mar. 16, 2020, the entire disclosure of which is hereby incorporated by reference.

### BACKGROUND OF THE INVENTION

### 1. Field of the Invention

The present invention relates to a game monitoring and play decision-making recommendation system. More particularly, the method relates to a game monitoring and play decision-making recommendation system for the sport of football.

### 2. Related Art

This section provides background information related to the present disclosure which is not necessarily prior art.

Football, also known as American football or gridiron football, is a favorite pastime of both young and old. The first rudimentary version of football was played in the 1800's and, since then, has progressively become a mainstay of American culture and has also reached widespread popularity internationally. This ever increasing popularity has resulted in numerous commercial opportunities, which in turn have resulted in considerable development of the sport. More particularly, there have been advancements in the way football is played, the way games are captured and disseminated to the public, and the way in which leagues and tournaments are formed. For example, the way football is played has had to adapt with improvements in technology such as improved head gear and body pads. The rules and regulations have also become increasingly complex and change on a regular basis to account for not only player conduct, but also coaching and referee conduct. Advancements in game capturing technology, such as high definition cameras and football tracking capabilities, have made referee decisions reviewable to a small degree of error, allowed the public to have a more intimate viewing experience, and have allowed coaches and their staff the ability to review the strengths or weakness of a given team or player. One of the most impactful results of advancements in game capturing technology includes the ability to accurately compile raw statistical data related to nearly every aspect of the game that has enabled a football obsessed culture to study and understand certain aspects of the sport not previously possible.

Despite these advancements, coaches and their staff are still limited in their ability to assimilate real-time data and often rely on past statistical data to help select plays believed to have the greatest probability of success. While there is an aggregate effect to each coaching decision, some decisions are more impactful on a team's ultimate win probability than others. For example, whether to go for it on 4^{th} down, whether to try for a two-point conversions, and whether to kick a field goal are a few of the more impactful decisions that a coach must make. In addition, football fans from every background are in constant search for improved formats for digesting statistical data related to all aspects of the game. The available statistical data is so voluminous that, in football, hindsight is not always 20/20 and coaching decisions are often the subject of scrutiny and controversy for weeks and years after they are made. Accordingly, there is a continuing desire to further develop and enhance data gathering, analysis, and presentation of data to allow a more accurate and instantaneous foresight into coaching decisions and assist coaches in making more informed decisions.

### SUMMARY OF THE DISCLOSURE

This section provides a general summary of the disclosure and is not to be interpreted as a complete and comprehensive listing of all of the objects, aspects, features and advantages associated with the present disclosure.

In accordance with one aspect of the disclosure, a monitoring and recommendation system for the sport of football is provided. The system comprises a system circuit that includes a monitor, a processor, and a memory device. The memory device has non-transitory storage that contains historical data related to at least one of an offensive or a defensive advantage that a first team has over a second team. The memory device further contains instructions that, when executed by the processor, cause the processor to: determine a field location spaced from the first down boundary line in which the first team or the second team has a threshold success rate at attempting a fourth down conversion, and visualize the field location, the first down boundary line, and a ball location on the monitor.

In accordance with another aspect of the disclosure, a monitoring and recommendation system for the sport of football is provided. The system comprises a system circuit that includes a controller having a processor and a memory device with non-transitory storage. Historical data is stored on the memory device and is related to at least one of an offensive or a defensive advantage that a first team has over a second team. The memory device further contains instructions that, when executed by the processor, cause the processor to: determine an estimated impact of a first play and a second play on a game winning chance based at least partially on the historical data, communicate the play having the greatest positive estimated impact on game winning chance, and after a play is selected and completed, compare an actual impact on the gaming winning chance with the estimated impact on the gaming winning chance.

Further areas of applicability will become apparent from the description provided herein. The description and specific examples in this summary are intended for purpose of illustration only and are not intended to limit the scope of the present disclosure.

### BRIEF DESCRIPTION OF THE DRAWINGS

The drawings described herein are for illustrative purposes only of selected aspects and are not intended to limit the scope of the present disclosure. The inventive concepts associated with the present disclosure will be more readily understood by reference to the following description in combination with the accompanying drawings wherein:

FIG. 1 is a schematic view of a game monitoring and decision-making recommendation system (“system”) in accordance with an aspect of the disclosure;

FIG. 2 is a schematic view of a system circuit used in conjunction with the system in accordance with an aspect of the disclosure;

FIG. 3 illustrates an exemplary team selection page on a user interface monitor in accordance with an aspect of the disclosure;

FIG. 4 illustrates an exemplary game screen page on the user interface in accordance with an aspect of the disclosure;

FIG. 5 illustrates the game screen of FIG. 4 at an advanced stage in the football game;

FIG. 6 illustrates an exemplary fourth down conversion indicator on the user interface in accordance with another aspect of the disclosure;

FIG. 7 illustrates the fourth down conversion indicator provided by a media outlet in accordance with an aspect of the disclosure;

FIG. 8 illustrates the game screen at an advanced stage in the football game with a fourth down conversion chance graphic in accordance with an aspect of the disclosure;

FIG. 9 illustrates the fourth down conversion chance graphic provided by the media outlet in accordance with an aspect of the disclosure;

FIG. 10 illustrates an exemplary fourth down conversion map on the user interface in accordance with another aspect of the disclosure;

FIG. 11 illustrates the fourth down conversion map at an advanced stage in the football game in accordance with an aspect of the disclosure;

FIG. 12 illustrates exemplary team customization features of the system in accordance with yet another aspect of the disclosure;

FIG. 13 illustrates an exemplary customization interface page for selecting individual attributes and advantages of certain aspects of at least one team in accordance with an aspect of the disclosure;

FIG. 14 illustrates an exemplary profile interface with predetermined or selected profiles wherein more than one attribute is pre-selected in accordance with an aspect of the disclosure;

FIG. 15 illustrates an exemplary play recommendation page on the user interface in accordance with another aspect of the disclosure;

FIG. 16 illustrates the play recommendation page with a recommendation for a play having the highest possibility in resulting in winning the football game in accordance with an aspect of the disclosure;

FIG. 17 illustrates the play recommendation page with a different recommendation for a play at an advanced stage in the football game, the recommended play having the highest possibility in resulting in winning the football game in accordance with an aspect of the disclosure;

FIG. 18 illustrates a tendency informer graphic on the play recommendation page in accordance with an aspect of the disclosure;

FIG. 19 illustrates an exemplary post-game graphic provided on the user interface in accordance with another aspect of the disclosure;

FIG. 20 illustrates the post-game graphic with a plotting point selected for additional information in accordance with an aspect of the disclosure;

FIG. 21 illustrates a flow chart of a recommendation method in accordance with one aspect of the disclosure;

FIG. 22 illustrates a continuation of the flow chart from FIGS. 21; and

FIG. 23 illustrates a further continuation of the flow chart from FIGS. 21 and 22.

### DESCRIPTION OF THE ENABLING DISCLOSURE

Example aspects will now be described more fully with reference to the accompanying drawings. In general, the subject aspects are directed to a game monitoring and play decision-making recommendation system for the sport of football. However, the example aspects are only provided so that this disclosure will be thorough, and will fully convey the scope to those who are skilled in the art. Numerous specific details are set forth such as examples of specific components, devices, and methods, to provide a thorough understanding of the present disclosure. It will be apparent to those skilled in the art that specific details need not be employed, that example aspects may be embodied in many different forms and that neither should be construed to limit the scope of the disclosure. In some example aspects, well-known processes, well-known device structures, and well-known technologies are not described in detail.

Referring to the Figures, wherein like numerals indicate corresponding parts throughout the views, the game monitoring and play decision-making recommendation system for the sport of football is intended to enhance data gathering, analysis, and presentation in order to improve real time comprehension of a team's ultimate winning probability or game winning chance to assist in making informed play calls and in-game decisions.

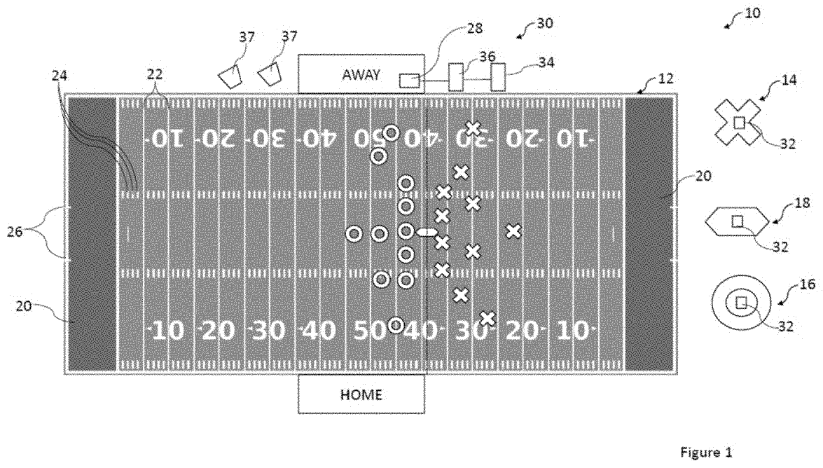

A schematic view of the monitoring and recommendation system 10 is provided in FIG. 1. The game monitoring and play recommendation system (“system 10”) is used in conjunction with football at all levels for assisting in pre, post, and real-time data processing and presentation. For example, the system 10 may be used in conjunction with pre-high school, high school, college, semi-professional, and professional leagues and tournaments. As illustrated, the system 10 can be used in real-time football matches and may also be used for pre-game strategizing and post-game review. FIG. 1 illustrates a football field 12 during an average contest between a first team 14 and a second team 16 and depicts a football 18. Each team includes eleven on-field players and numerous other players, support staff, and coaching staff on the sidelines. A standard football field 12 is 120 yards long with the final 10 yards on either side comprising an end zone 20. The length of the football field 12 is divided by a series of yard marks 22, spaced every 5 yards. Hash marks 24 are located between the yard marks 22 in 1-yard increments. The hash marks 24 are arranged in two rows of parallel lines on either side of a center of the football field 12. Goal posts 26 are located centrally at an outer edge of each end zone 20.

The first team 14 and second team 16 take turns having the football 18 on offense, wherein the ultimate goal is to carry the football 18 into the opposing team's end zone 20 or kick it through the goal posts for a field goal. Each offensive turn includes a drive comprising a series of plays to advance to the football 18 while the defensive team attempts to prevent the offensive team from advancing and to gain possession of the football. A team's probability of success on advancing the ball in any given play is dependent on a very large number of factors that cannot feasibly be taken into account by the human mind. Within this context, the system 10 provides a unique way of gathering data, analyzing data, and presenting the data in an easy to digest format in order to quickly make and convey foresights to a game or play to make a recommendation on which play offers the greatest increase in a team's overall chance of winning the game.

Without limitation, the data used to analyze and make predictive recommendations by the system 10 includes historical data, i.e., any statistical information related to events before a game is played. This historical data may be categorized to include a player's individualistic statistics and/or a team's synergistic statistics relating previous games played, such as passing yards, rushing yards, sacks, interceptions, field goal percentages and ranges, etc. The historical data may further be categorized to include individual attributes, such as those showcased in annular combines, or an individual kicker, quarterback, back-up quarterback, running back's in-game statistics. This historical data may also be categorized to include coaching statistics (such as success percentages) from an overall season, individual games, or even individual types of plays. Historical data may further be categorized to account for changes in a team's or individual's performance that have resulted from weather, the quality of the opposing teams, player injuries, or types of games, e.g., friendly, regular season, playoffs, super bowl, final tournament games, and/or bowl games. The system 10 may also account for and categorize real-time data, i.e., similar types of data listed above but only in the context of a game that is currently being played. In order to determine temporary or recent advantages one team may have over another, all of these statistics may be obtained for the first team 14 and the second team 16 and compared to one another.

With continued reference to FIG. 1, the data may be gathered by third party resources, reviewing previous game recordings, and in real-time (in game) via inputs from a team's coaching staff. Real-time data may be gathered by manually entering data as the game is played into a user interface 28 of the system 10. Alternatively, or in addition to manual input, real-time data may be gathered by location aware technology 30 that tracks ball movement and individual player movement. For example, location aware technology 30 may include sensors 32, such as RFID sensors, located on the football 18 and individual players, wherein the system 10 includes an antenna 34 to pick-up location signals from individual sensors that are filtered through a reader or interrogator 36. The location aware technology 30 may further include various types of readers 37 that do not require separate sensors such as optical readers, object detection, etc. Real-time data may be categorized by team or individual players.

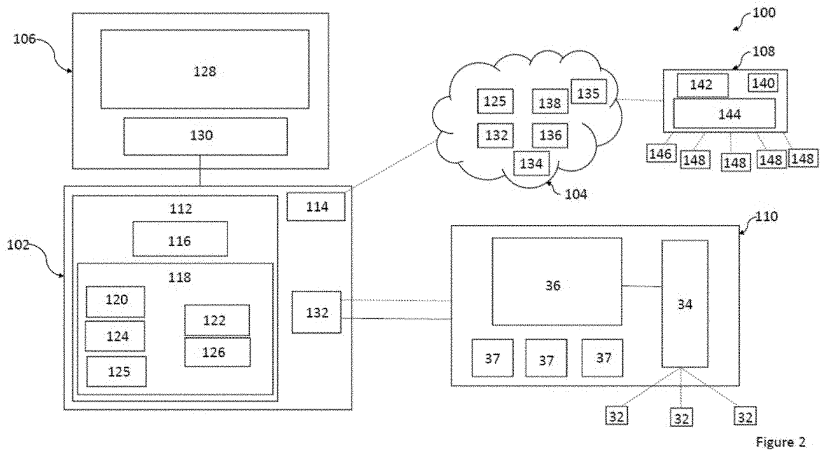

Referring now to FIG. 2, a schematic system circuit 100 is presented in accordance with one aspect of the disclosure. The various elements provided therein allow for a specific implementation. Thus, one of ordinary skill in the art of electronics and circuits may substitute various components to achieve a similar functionality. The circuit 100 includes a GCU system 102, a server network 104, a first user interface system 106 (corresponding to the user interface 28), a second user interface system 108, and a location aware circuit 110 (corresponding with location aware technology 30).

In accordance with one aspect, certain operations of the system circuit 100 can be controlled via communication between the first user interface 106 and the GCU system 102, which includes a controller 112 and a communications module 114. The controller 112 includes a processor 116 and a memory 118 having machine readable non-transitory storage. Programs and/or software 120 (such as arduino IDE, Windows, Linux, Android, iOS) may be saved on the memory 118 and so is an input data 122 obtained via the first user interface 102 and/or the location aware circuit 110, profile data 124 related to saved user preferences, and historical data 125 as previously described. An authenticate data 126 is also saved on memory 118 as will be described below. The processor 116 translates and carries out instructions based on the software 120, input data 122, profile data 124, and historical data 125 and presents the translated data to a monitor 128 associated with the user interface system 106. The user interface system 106 may further include a series of inputs 130 that can be used to select the presentation of information and add real-time data to input data 122. Inputs 130 may be keys, touchscreen voice command, mouse, etc. The authentication data 126 (such as a password, finger print, or voice recognition) can be used to prevent another, unwanted user access to the input data 122, profile data 124, or presentation selections that are displayed on the monitor 128.

As previously explained, the location aware circuit 110 may include one or more sensors 32 and an antenna 34 to pick-up location signals from individual sensors that is filtered through a reader or interrogator 36. In addition, one or more readers 37 that do not require separate sensors such as optical readers, object detection, etc. may be employed to track the movement of the football, a team, or individual players. The GCU system 102 may further include a conversion module 132 that converts the readings from the location aware circuit 110 into readable input data 122. Alternatively, or in addition to the location aware software 110, input data 122 related to real-time statistics, profiles, modifiers may be provided through manual entry via inputs 130 of the first interface system 106 or via third-party information provided via the server network 104.

In addition to having historical data 125 saved locally in GCU system 102, historical data 125 may also be saved and located in the server network 104 that can be communicated with via the communications module 114 in a wired or wireless interne connection. Data from memory 118 can thus be sent to and received from the server network 104. The server network 104 may store other types of data as well. For example, profile data 124, software updates 132, authentication data 134 (to confirm data 126), real-time data 135, social network data 136, and media data 138. Social network data 136 may also be associated with the authentication data (126, 134) to connect an individual user or team to various social media platforms associated with the user interface system 106. For example, social media connectivity may allow sharing game content like profile data, game screenshots, play-by-play analysis, streaming videos, and photographs—including screen captures from the monitor 128.

The second user interface system 108 includes a second series of inputs 140 related to the presentation of data that can be distributed by commentators and media outlets. The second user interface system 108 may include each of the functionalities and elements described in relation to the first user interface 106 and GCU system 102 or may be provided with a more simplified interface. For example, in addition to having a second series of inputs 140, the second user interface 108 may include a monitor 142 for the presentations of graphics that are presented as a result of statistical comparisons from data selected by the second series of inputs 140 from the server network 104. Statistical comparisons may be output as a result of a Monte Carlo simulation instructions performed by software that account for in-game and pre-game data. Once a graphical presentation has been selected, it can be transmitted via a media networking module 144 that transmits the image to in-stadium monitors (screens) 146 and/or out-of-stadium monitors 148. As such, inputs 140 may also a media outlet to modify video feeds.

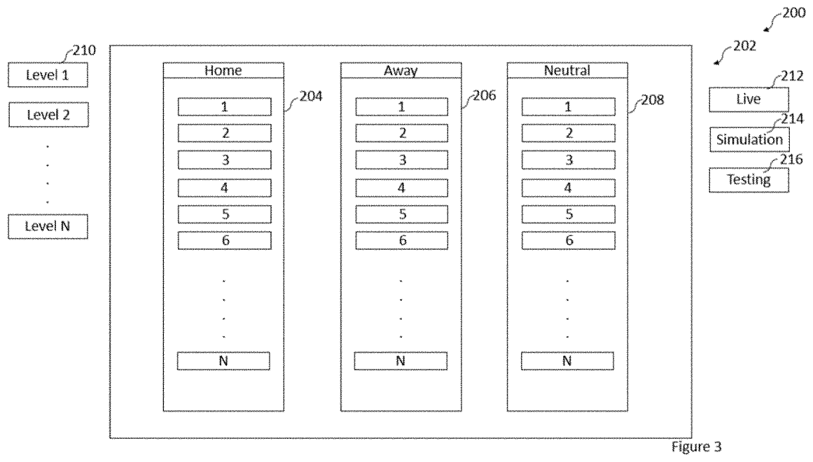

FIGS. 3 through 20 provide exemplary images that may be presented on the monitor of the first user interface 106, the monitor of the second user interface 108, and/or through the media networking module 144 via a visualize system 200 that is configured as a software implemented application or web-based browser.

With specific reference now to FIG. 3, the visualize system 200 may initially present an opportunity to select two teams (from among a listing of many teams) that are matched together via a team selection screen 202. Individual team selections include selecting if the team is playing at home 204, away 206, or if both teams are in a neutral stadium 208. The selection of teams may also be further assisted by initially selecting a level 210 from pre-high school, high school, college, semi-professional, and professional levels. Once the teams are selected, options to receive a live stream 212, a pre-game simulation 214, or a testing simulation 216 may be selected. Based on these selections, data from the server network 104 is accessed to determine advantages and disadvantages of each team in certain areas of a their game. This information may be updated/modified as a result of input data 122 or real-time data 135.

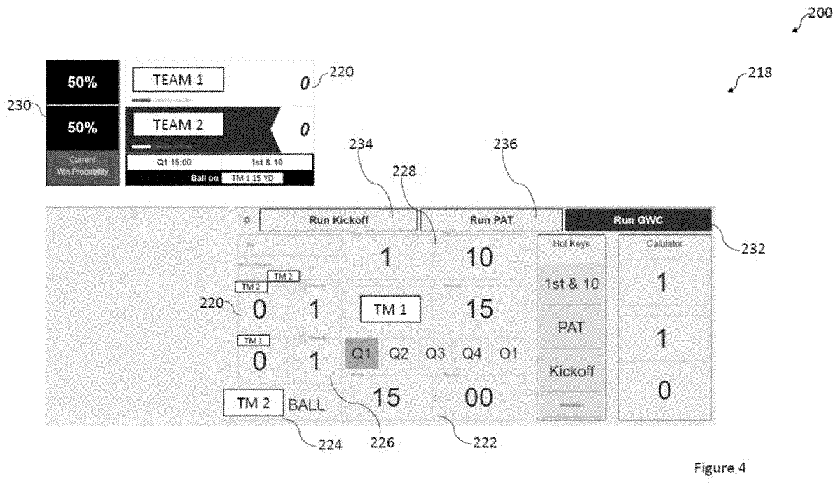

After team selections are made in FIG. 3, FIG. 4 presents a game screen 218 that visualizes current game information such as the scores of the first team and second team 220, the time remaining in the game 222, ball possession 224, remaining timeouts 226, and offensive drive information (play number and yards to conversion) 228. It will be appreciated that other information can also be included. In addition, the game screen 218 further includes predictive visualizations. For example, a current win probability indicator 230 provides a game winning probability as a percentage measurement. As illustrated, the current win probability of each team is 50%, respectfully. Further, the information described in numeral designations 220 through 228 may be manually edited from actual numbers to predicted or simulated numbers and the game winning probability can be recalculated with GWC button 232. In addition, depending on the offensive teams field position, a kickoff button 234 may initiate a kickoff simulation to recommend an on-side or regular kick-off based on which play has the greatest chance for winning the game. A run PAT button 236 is also included and may measure game winning probably in view of attempting an extra point after a touchdown.

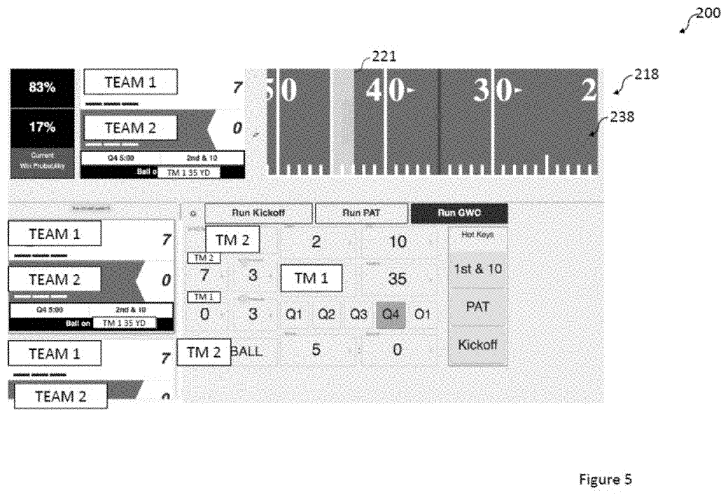

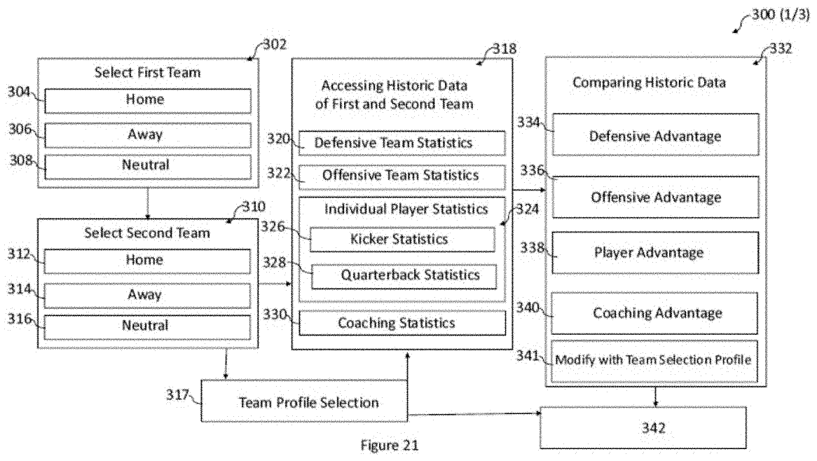

FIG. 5 illustrates the game screen 218 at an advanced stage in a game between a first team and a second team. Team 1 has a 7 point advantage with 5:00 minutes left in-game. The ball is on the 35-yard line of team 1 and the drive is second down and 10 yards remaining. Based on the previously described data, a cost-benefit algorithm can be initiated wherein a distance from the conversion line that represents a boundary 221 in which it becomes more beneficial to “go for it” on fourth down can be determined. One example cost-benefit algorithm is represented in an exemplary flowchart depicted in FIGS. 21 through 23 and compares the benefits of punting, attempting a field goal, or going for a fourth down conversion. Software may then visualize the boundary in a fourth down conversion indicator 238.

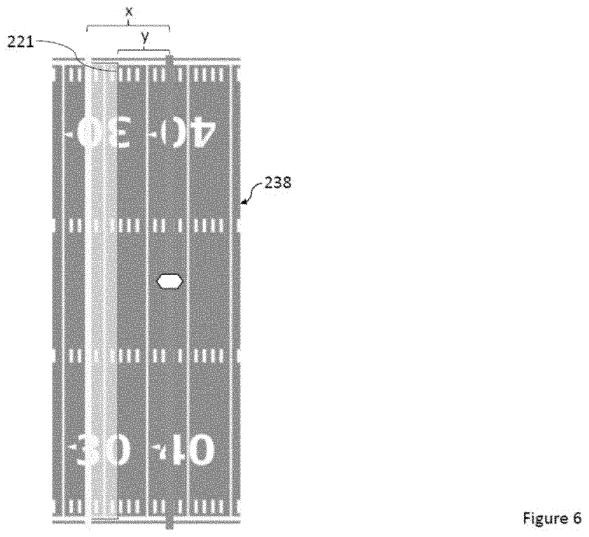

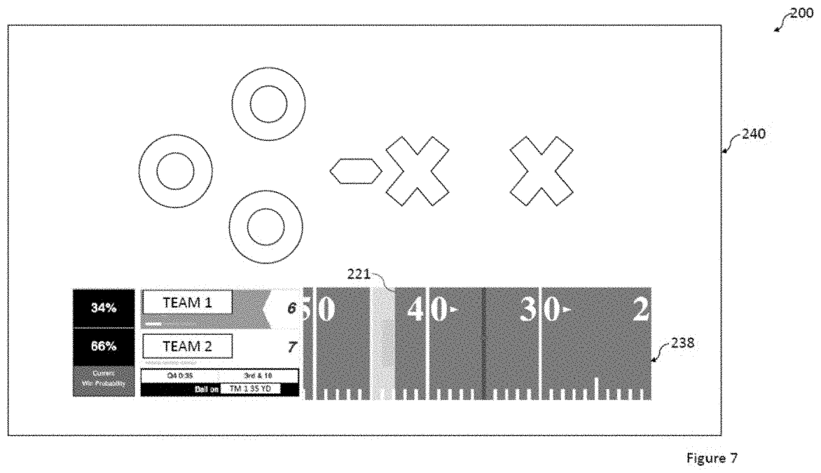

FIG. 6 is an enlarged view of the fourth down conversion indicator 238, wherein a first distance X represents the distance required to convert a first down and a second distance Y represents the boundary 221 (i.e., the distance ball needs to advance for it to become more beneficial to “go for it” on fourth down—the recommendation “go for it” occurring once it provides the greatest win probability over other plays). FIG. 7 illustrates one example of a monitor 146, 147, wherein the media networking module 144 changes a video feed to illustrate a modified version of the fourth down conversion indicator 238, which may be overlaid over live game footage 240.

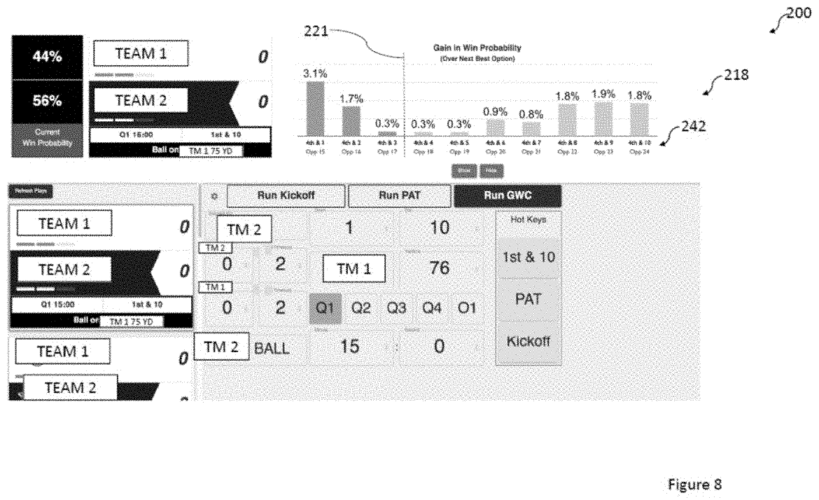

With reference now to FIG. 8, the game screen 218 is illustrated having a graphical illustration of the game winning probability 242 which is based (at least in-part) on the fourth down conversion chances, wherein the boundary 221 is located between the 4^{th} and 3^{rd} yard. As such, in any 4^{th} down play with more than 3 yards remaining within the opponents 18 and 24 yard line, it increases the overall game winning chance to attempt a field goal. The graphical illustration 242 represents a cost-benefit of each yard in a 10-yard range, wherein the Y-axis represents a percentage increase of chances to win the game than if the next best choice is selected. For example, at 4^{th} and 1-yard, going for the 4^{th} down conversion corresponds to a 3.1% improvement to game winning probability over kicking a field goal. In another example, at 4^{th} and 10-yards, attempting a field goal corresponds to a 1.8% improvement to game winning probability.

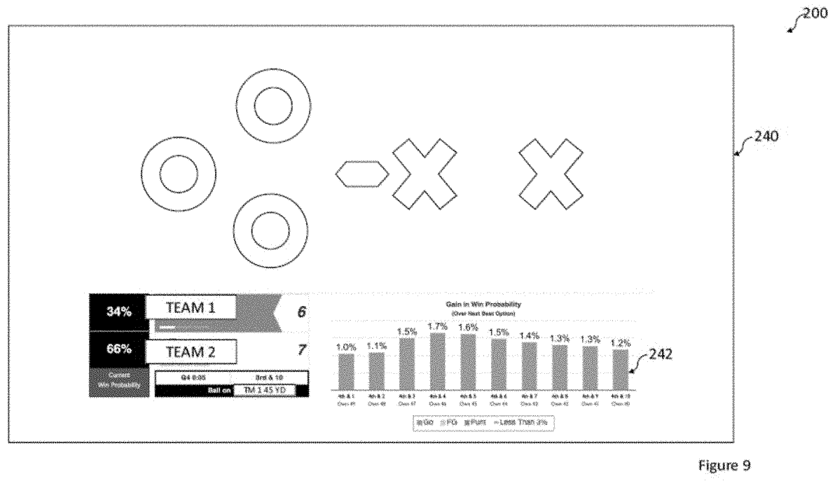

FIG. 9 illustrates another example of a monitor 146, 147, wherein the media networking module 144 changes a video feed to illustrate a modified version of the fourth down conversion indicator 238, which may be overlaid over live game footage 240.

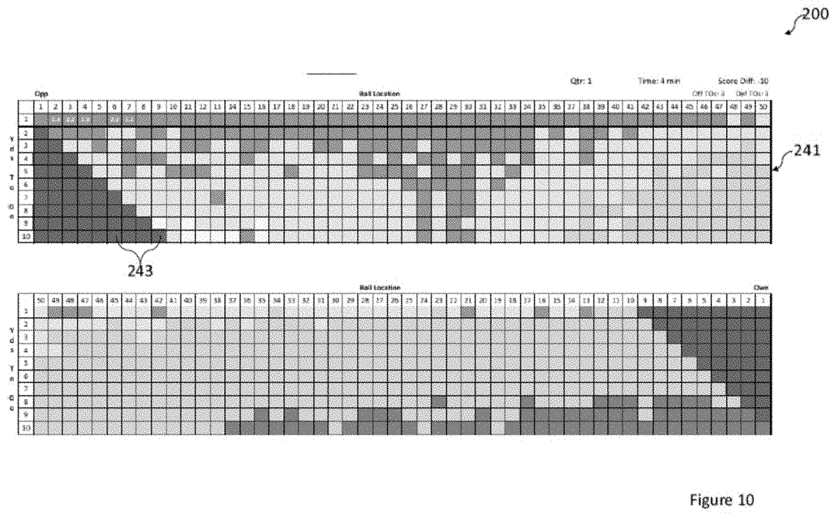

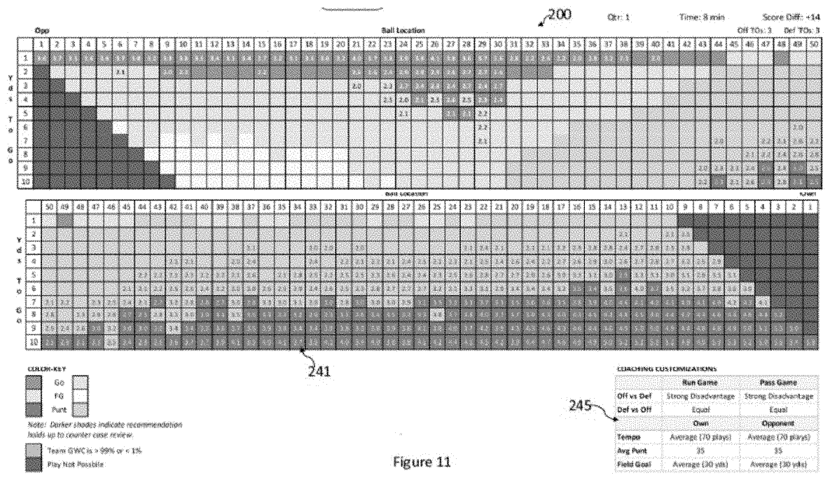

FIGS. 10 and 11 illustrate a 4^{th} down conversion map 241 wherein the X-axis represents every yard of the football field 12 and the Y-axis represents yards remaining until first down. Each tile 243 is color coded with a recommended play, wherein the recommendations include one of going for first down, kicking a field goal, and punting. In one example, a color corresponds to each option wherein a darker shade of the color represents a recommendation that has undergone a counter-case analysis methodology. More specifically, the counter-case analysis methodology may include performing a game simulation wherein the teams are provided with extreme attributes, e.g., the team on offense is given weak attributes and the team on defense is given strong attributes. If the system still recommends the same action as before (with the respective team's actual attributes), then the color turns dark. If the system recommends a different action, then the tile remains a light color. It will be appreciated that other recommendations may be employed, such as a running play or a passing play. Tiles 243 may include numbers that represent a percentage increase of chances to win the game than if the next best choice is selected. The 4^{th} down conversion map 241 can be continuously updated by software 120 throughout the game, for example, on a play-by-play basis, a drive-by-drive basis, predetermined time intervals, or other in-game occurrences may change the color or the shade of color. It will be appreciated that other features, factors, and variables may be employed.

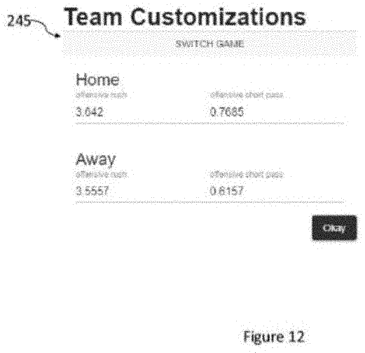

The 4^{th} down conversion map 241 may further be changed manually via user inputs with the user interface system 106. More particularly, FIG. 11 illustrates the 4^{th} down conversion map 241 with coaching customization features 245. More particularly, modifiers can be attributed to each team in-game for improved accuracy, particularly with events that cannot easily be predicted with historical data. For example, run game and pass game advantages may be selected based on player injury or weather that makes a passing game or field goals difficult. Likewise, respective tempos of teams (plays within a given period of time) can be adjusted for a better prediction of total plays for each respective team remaining. In addition, average punt yards and average field goal yards that are above a selected threshold of success can be selected. FIG. 12 is an additional image of coaching customization features 245, including the home team's offensive rush rating and offensive short pass rating and also including the away team's offensive rush rating and offensive short pass rating.

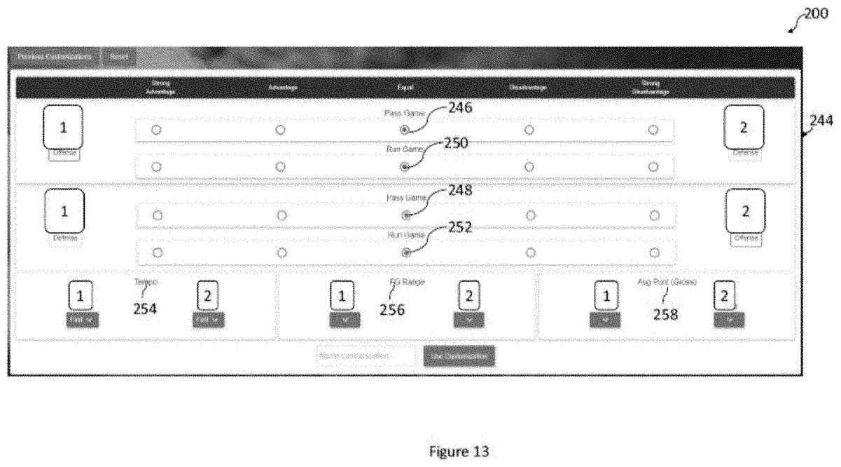

FIG. 13 illustrates an exemplary customization interface 244 in accordance with another aspect, wherein advantage modifiers of certain categories including offensive 246 and defensive 248 passing game and offensive 250 and defensive 252 running game can be selected. This screen may be presented directly after the team selection screen 202 or at any time in game. These modifiers include strong advantage, advantage, equal, disadvantage, and strong disadvantage. It should be appreciated that other modifiers and descriptors may be employed. In addition, respective team's tempo modifiers 254 may be selected including very fast (90+Plays), fast (80+Plays), average (70+Plays), slow (60+Plays), and very slow (50+Plays). Field goal range modifiers 256 may also be selected including elite (40+yards), above average (35+yards), average (30+yards), below average (25+yards), and unlikely (20+yards). The field goal range modifiers 258 may represent the point at which a field goal chance has historically been over 50% success, 75% success, or other predetermined percentages. An average punt yard modifier 260 includes 20 yards to 50 yards in 5-yard increments. These modifiers may be changed at any point in a simulation, pre-game, or in-game as input data 122.

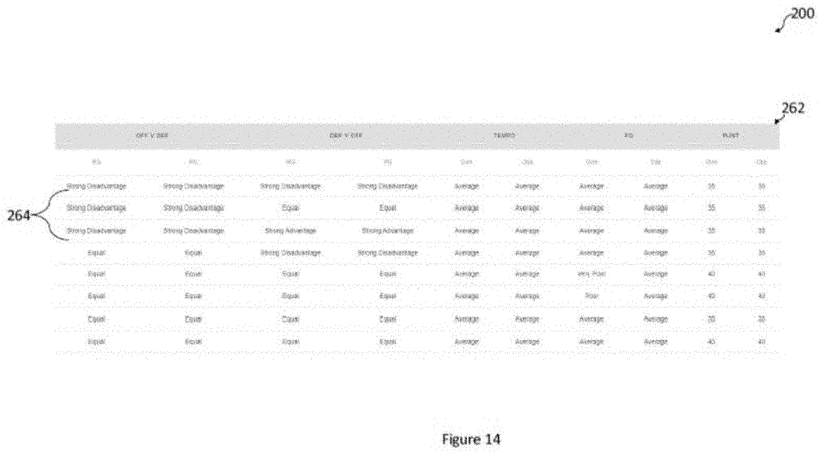

FIG. 14 illustrates a profile interface 262 wherein rows of previously selected modifiers are available for quickly switching between previously constructed profiles 264. For example, a profile may be associated with players such as a back-up quarterback, on-field player teams, etc. Profiles may also be associated with certain game scenarios, such as being down with limited time remaining (e.g., 4^{th} Quarter and down by more than 7), which may result in a larger necessity to play in faster tempo or more aggressive passing game. Modifiers can be used independently in instances wherein statistics are not available for both teams (high school) or may further modify team and player attributes based on historical data when it is available. This screen may be presented directly after the team selection screen 202 or at any time in game.

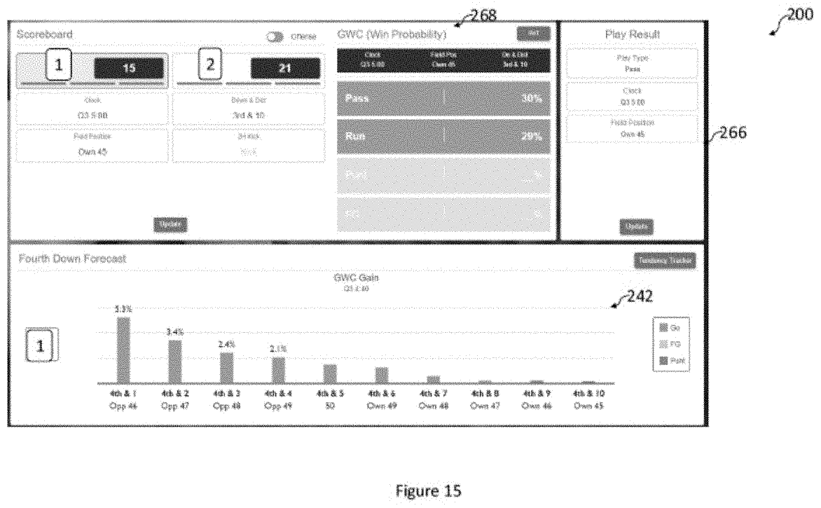

FIG. 15 presents an exemplary play recommendation screen 266, wherein field position, score, timing, down, and distance to convert are illustrated. Similarly to the previous aspect presented in FIG. 8, a graphical representation of the game winning probabilities 242, which is based (at least in-part) on the fourth down conversion chances, is presented wherein a cost-benefit of each yard in a 10-yard range indicates if a team should go for a 4^{th} down conversion, attempt a field goal, or punt. A recommendation graphic 268 (“Scoreboard section”) is also presented. For example, in the case the game state is the first team has 15 points and the second team has 21 points, and the first team is on offense in the 3^{rd} quarter with 5:00 remaining, facing a 3^{rd} and 10 from their Own 45-yard line. On the 3^{rd} down, the graphic 268 displays a recommendation from the system that if the first team selects a pass play they are expected to go on to win the game 30% of the time and if the first team selects a run play they are expected to go on to win the game 29% of the time. While section 242 always reflects 4^{th} down recommendations and increases in win probability over the next best option, the graphic 268 represents absolute win probabilities for whatever game state/scenario that is being defined (which can be 1^{st}, 2^{nd}, 3^{rd}, or 4^{th} down).

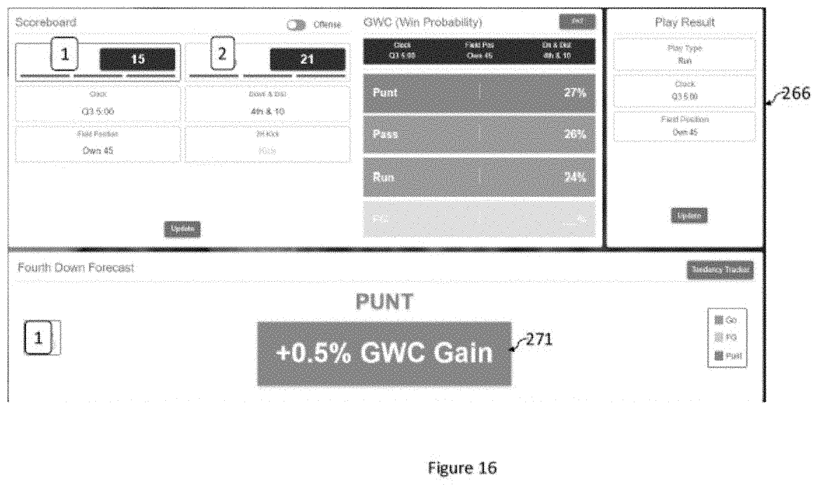

FIG. 16 is a sequential view from FIG. 15 and provides a graphical recommendation for a fourth down conversion/field goal attempt as measured by the increase or decrease of the ultimate game winning probability 242. The recommendation provides the relative increase to the game winning results as percentage increase of chances to win the game than if the next best choice is selected. As shown, the recommendation is to punt, as presented by relative increase graphic 267, which will result in a relative +0.5% increase in the chance of game winning result over the next best option, which is to pass. Because of the advanced stage in the game and the fact that the offensive team is losing by 6 points, the game winning chance is only 27%.

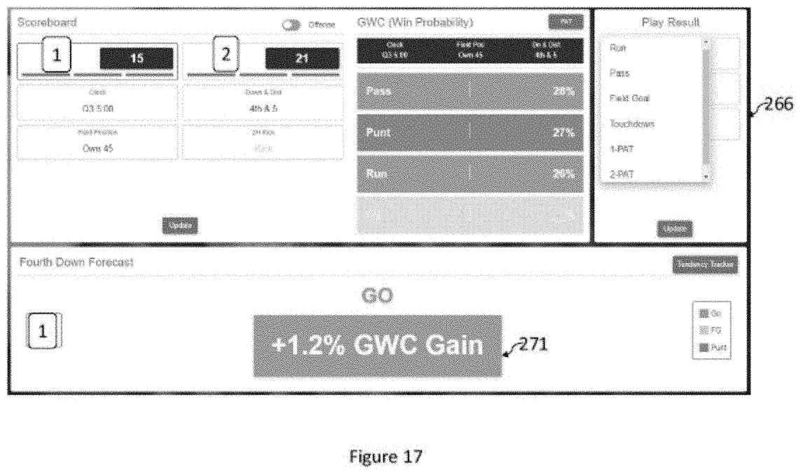

FIG. 17 is an alternative sequential view of FIG. 15 wherein the recommended choice is to go for a conversion and, more particularly, to pass. It should be noted that while the pass is recommended, a punt is recommending over running.

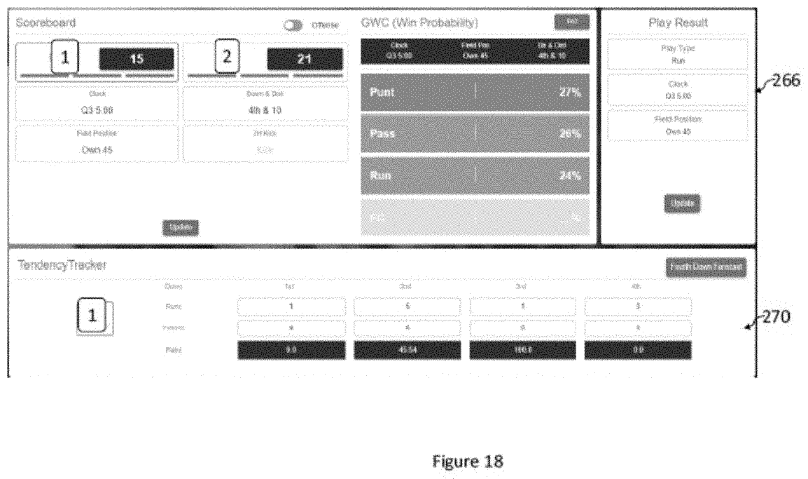

FIG. 18 is another view of the play recommendation screen 266, wherein the fourth down conversion chances 242 are replaced by a tendency informer 270, wherein in-game pass-to-running ratios are illustrated and separated by down. It will be appreciated that a variety of other scenarios can be presented depending upon the team, score, down, down location, and from a variety of other factors.

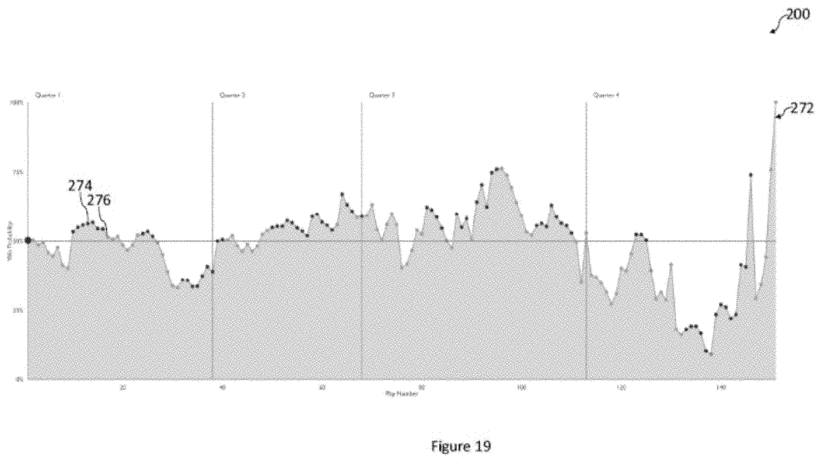

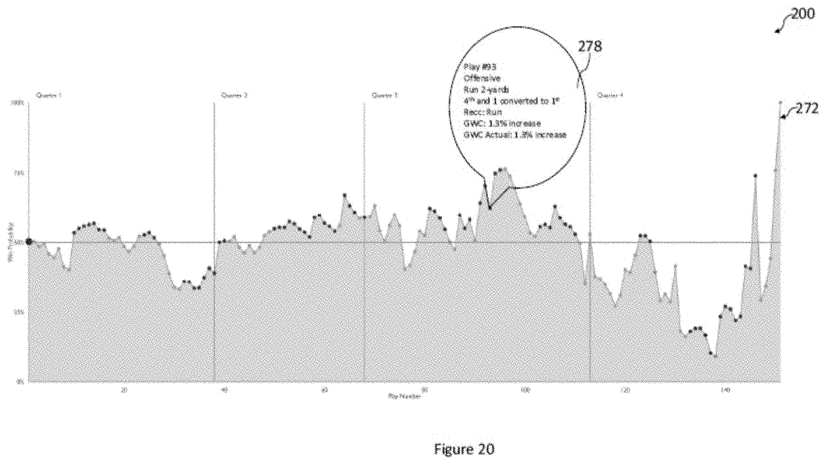

FIGS. 19 and 20 provide exemplary post-game graphics 272 that map game winning probability changes after each play. Each play includes a plotted point 274 with a team identifier such that drives are easily identifiable between teams. The plotted points 274 represent a pre-snap win probability. Certain plays may be indicated as an important play 276, wherein the game winning chance was changed by a predetermined amount by scoring, turnovers, etc. Selections may be made to identify only those plotted points 274 wherein a recommendation was followed and did not result in the predicted value and selections may be made to identify only those plotted points 274 wherein a recommendation was not followed. Such selections may help a coach refine profile data 124. Once a plotted point 274 is selected, an inquiry graphic 278 is provide information about the play.

FIG. 21 illustrates an example flow chart of a recommendation method 300 in accordance with one aspect of the invention. The method 300 begins by selecting a first team 302, if the first team is playing at home 304, away 306, or at a neutral location 308 with respect to the second team. The method continues by selecting a first team 310, if the first team is playing at home 312, away 314, or at a neutral location 316 with respect to the second team. Step 310 may be followed by a step 317 of selecting a team profile out of the options presented in relation to FIGS. 13 and 14. Step 317 may include choosing premade profiles from a profile data or an individual selection of attributes. Step 317 or step 310 may be followed by a step 318 of accessing historic data of the first and second team. Step 318 may include: obtaining defensive team statistics 320 from the first and the second team; obtaining offensive team statistics 322 (passing and running statistics) from the first and the second team; obtaining individual player statistics 324 from the first and the second team; and obtaining coaching statistics 330 from the first and the second team. The step of obtaining individual player statistics 324 from the first and the second team may include kicker statistics 326 (such a field goal accuracy and punt range) and quarterback statistics 328 such as passing yards per game. Next, the historical data is compared 332. The comparison step 332 may include calculating a defensive advantage 334 (which may be positive or negative for either given team), an offensive advantage 336 (which may be positive or negative for either given team), a player advantage 338 (for example, a comparison of kickers or quarterbacks), and coaching advantage 340 (based on statistical win-losses). Step 332 may further include modifying 341 the advantages with a team selection profile. For example, if an important player is playing injured or if a team is unrested going into the game.

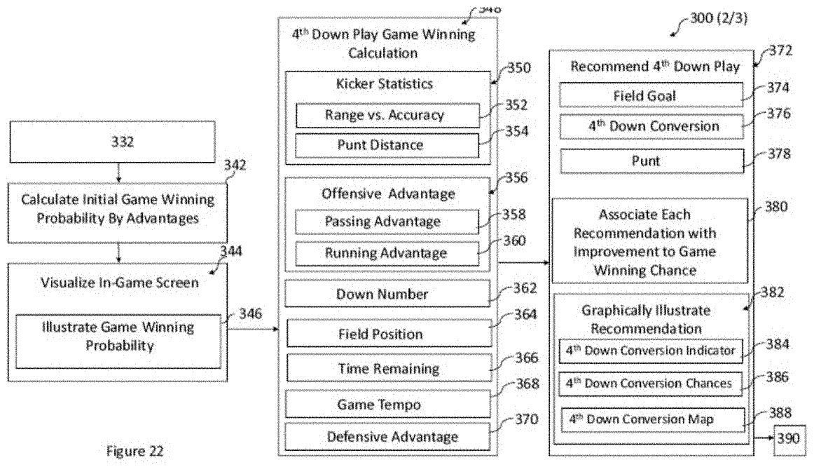

FIG. 22 provides a continuation of method 300 wherein step 332 is followed by calculating 342 an initial game winning probability by comparing an overall offensive advantage (including player advantages) with overall defensive advantage (including player advantages). A visualization is produced 344 that illustrates 346 the calculated game winning probability. Next, a 4^{th} down play game winning calculation 348 is provided. Step 348 may include reviewing 350 kicker 350 statistics, reviewing the offensive advantage 356, reviewing the down number 356, the field position 364, the time remaining 366, the game temp 368, and the defensive advantage 370 of the other team. The step 350 may include a range vs. accuracy analysis 352 and a punt distance analysis 354. Step 356 may include comparing a passing advantage 358 to a running advantage 360. After step 348, the method 300 continues by recommending 372 a 4^{th} down play. Step 372 includes recommending a field goal 374, recommending a 4^{th} down conversion attempt 376, or recommending a punt 378. Step 372 may also include associating each of options 374 through 378 with an improvement to a game winning chance 380. In addition, step 382 may include graphically illustrating the recommendation 382 via a 4^{th} down conversion indicator 384 (see FIGS. 5 through 7), a 4^{th} down conversion chances 386 (see FIGS. 8, 9 and 15), and/or providing a 4^{th} down conversion map 388 (see FIGS. 10 and 11). Step 382 may also include providing a relative or absolute value to the game winning chance improvement.

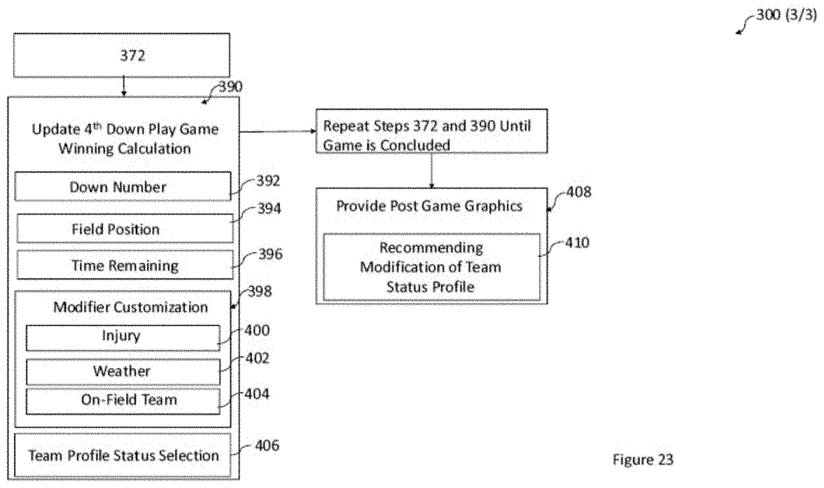

FIG. 23 provides a further continuation of method 300 wherein step 372 is followed by updating 390 the 4^{th} down play game winning calculation. Step 390 may include the same steps from 348. As shown in the illustrated example, step 390 includes updating the down number 392, field position 394, time remaining 396, updating a modifier customization 398, and/or selecting a team profile status 406. Step 398 may include modifying a team's advantage if a player is injured 400, if the weather is poor or good 402 (e.g., makes passing/kicking difficult), or if other changes are made to the on-field players, in-game player or team performance. Step 406 may include predetermined profile modifiers based on a selection established on-field teams (e.g., special teams).

Steps 372 and 390 are repeated as the game progresses, wherein the ultimate end goal is to continually increase the game winning probability until it reaches 100% through aggregate choices. After the game is over, the method 300 continues by providing post game graphics 408 and recommending modifications of predetermined team status profiles 410.

The method presented in FIG. 21 through 23 may be sequentially followed or may alternatively be non-sequential. The method may utilize only some, all, or additional steps as those presented in the Figures. It should be readily apparent that steps that are part of the method may include implementation of those features illustrated throughout the entire disclosure, including, methods that may be carried about by one or more controllers, processors, or other systems.

Other methods may be employed for making play recommendations such as the methodologies utilized by the ZEUS system as disclosed in a publication titled “New computer model thinks it's a football coach ZEUS can help NFL coaches call the next play, evaluate players”, which was published on Apr. 20, 2006 and is hereby incorporated by reference.

It should be appreciated that the foregoing description of the aspects has been provided for purposes of illustration. In other words, the subject disclosure it is not intended to be exhaustive or to limit the disclosure. Individual elements or features of a particular aspect are generally not limited to that particular aspect, but, where applicable, are interchangeable and can be used in a selected aspect, even if not specifically shown or described. The same may also be varies in many ways. Such variations are not to be regarded as a departure from the disclosure, and all such modifications are intended to be included within the scope of disclosure.

1. A monitoring and recommendation system for a sport of football comprising:
a system circuit including a monitor, a processor, and a memory device;
the memory device having non-transitory storage that contains historical data that is related to at least one of an offensive or a defensive advantage or disadvantage that a first team has over a second team;
the memory device further containing instructions that, when executed by the processor, cause the processor to:
determine a field location spaced from a first down boundary line in which the first team or the second team has an increase in a probability of winning a game by attempting a fourth down conversion based at least partially on the historical data; and
visualize the field location, the first down boundary line, and a ball location on the monitor.

2. The monitoring and recommendation system of claim 2, wherein the visualization includes a football field and the field location, the first down boundary line, and the ball location are overlaid over the football field in real-time.

3. The monitoring and recommendation system of claim 2, wherein the increase in the probability of winning the game includes an absolute percentage increase in a probability of winning the game visualized on the monitor.

4. The monitoring and recommendation system of claim 1, wherein the increase in the probability of winning the game includes a relative percentage increase in probability of winning the game over a next best play visualized on the monitor.

5. The monitoring and recommendation system of claim 1, wherein the memory device further contains profile data and the instructions further cause the processor to modify the increase in the probability of winning the game based on the profile data, the profile data including at least one of on-field team status, weather, or player unavailability.

6. The monitoring and recommendation system of claim 1, wherein the instructions further cause the processor to make a recommendation associated with reaching the field location by one of a running play or a passing play.

7. The monitoring and recommendation system of claim 6, wherein, upon failing to reach the field location, the recommendation further includes one of a punting play or a field-goal play.

8. The monitoring and recommendation system of claim 7, wherein the instructions further cause the processor to modify the recommendation between the running play and the passing play based on which play includes a larger percentage increase in an estimated probability of winning the game.

9. The monitoring and recommendation system of claim 8, wherein the instructions further cause the processor to determine a second field location spaced from first down boundary wherein a team in possession should attempt a field goal on a fourth down.

10. The monitoring and recommendation system of claim 9, wherein the instructions further cause the processor add the second field location to the visualization.

11. A monitoring and recommendation system for a sport of football comprising:
a system circuit including a controller having a processor and a memory device with non-transitory storage;
historical data stored on the memory device and related to at least one of an offensive or a defensive advantage that a first team has over a second team;
the memory device further containing instructions that, when executed by the processor, cause the processor to:
determine an estimated impact of a first play and a second play on a game winning chance based at least partially on the historical data;
communicate the play having the greatest positive estimated impact on game winning chance; and
after a play is selected and completed, compare an actual impact on the game winning chance with the estimated impact on the game winning chance.

12. The monitoring and recommendation system of claim 11, wherein the instructions further cause the processor to repeat the steps of determining and estimated impact on game winning chance, communicating a play based upon the estimated impact of game winning chance, and comparing the actual impact on the game winning chance with the estimated impact on the game winning chance for a plurality of subsequent plays.

13. The monitoring and recommendation system of claim 12, wherein the instructions further cause the processor to modify the estimated impact of on the game winning chance based upon one or more instances of the estimated impact on the game winning chance being more or less than the actual impact of the game winning chance.

14. The monitoring and recommendation system of claim 12, wherein the instructions further cause the processor to modify the estimated impact upon the estimated impact on the game winning chance after a predetermined number of occurrences of the estimated impact on the game winning chance being more or less than the actual impact of the game winning chance.

15. The monitoring and recommendation system of claim 12, further including a monitor and wherein the instructions further cause the processor to record and visualize the estimated impact on the game winning chance against the actual impact on the game winning chance for each play on the monitor.

16. The monitoring and recommendation system of claim 15, wherein the instructions further cause the processor to visualize the estimated impact on the game winning chance against the actual impact on the game winning chance for each play with a graphical representation as a function of time and overall game winning chance on the monitor.

17. The monitoring and recommendation system of claim 16, wherein the instructions further cause the processor to visualize the estimated impact on the game winning chance and the actual impact on the game winning chance for each play as a plot point.

18. The monitoring and recommendation system of claim 17, wherein the instructions further cause the processor to display a recommended play and a actual play for each plot point when it is interfaced with.

19. The monitoring and recommendation system of claim 12, wherein the instructions further cause the processor to modify the estimated impact to the game winning chance if one or more player substitutions are made.

20. The monitoring and recommendation system of claim 12, wherein the instructions further cause the processor to modify the estimated impact of the game winning chance based upon weather conditions.
